(19) United States
(12) Patent Application Publication
(10) Pub. No.: US 2024/0396759 A1
(43) Pub. Date: Nov. 28, 2024

(54) DEVICES, METHODS AND COMPUTER READABLE MEDIA FOR MULTIPLEXING NACK-ONLY HARQ FEEDBACK

(71) Applicant: Nokia Technologies Oy, Espoo (FI)

(72) Inventors: Ugur Baran ELMALI, Munich (DE); Volker PAULI, Munich (DE); Naizheng ZHENG, Beijing (CN); David BHATOOLAUL, Swindon (GB); Athul PRASAD, Naperville, IL (US); David NAVRATIL, Espoo (FI)

(21) Appl. No.: 18/689,001

(22) PCT Filed: Sep. 27, 2021
(86) PCT No.: PCT/CN2021/121070

§ 371 Date: Mar. 4, 2024

(51) Int. Cl. H04L 12/18; H04L 1/1812; H04L 1/1829; H04W 72/02; H04W 72/21

(52) U.S. Cl. CPC H04L 12/1868; H04L 1/1854; H04W 72/02; H04W 72/21; H04L 1/1812

(57) ABSTRACT

Disclosed are methods and apparatus for multiplexing NACK-only HARQ feedback. A terminal device in a communication network may comprise at least one processor and at least one memory having computer program code stored thereon. The at least one memory and the computer program code may be configured, with the at least one processor, cause the terminal device to perform: receiving, from a network device, one or more uplink control channel configurations for transmitting HARQ feedback for multicast transmission of one or more services; receiving, from the network device, the multicast transmissions of the one or more services; converting HARQ feedback bits of the HARQ feedback for the multicast transmissions of the one or more services; multiplexing the converted HARQ feedback bits into a multiplexed HARQ feedback; selecting a physical uplink control channel (PUCCH) resource for transmission of the multiplexed HARQ feedback; and transmitting the multiplexed HARQ feedback using the selected PUCCH resource.

### TECHNICAL FIELD

Various example embodiments described herein generally relate to communication technologies, and more particularly, to devices, methods, and computer readable media for multiplexing negative acknowledgement only (NACK-only) hybrid automatic repeat request (HARQ) feedback

### BACKGROUND

Hybrid automatic repeat request (HARQ) may be used for multicast service and unicast service. When a user equipment (UE) device succeeds in decoding a physical downlink shared channel (PDSCH) transmission of a point to multipoint (PTM) service, the UE device may transmit an acknowledgement (ACK) feedback message. When a UE device cannot decode a PDSCH transmission of a PTM service, the UE device may transmit a NACK feedback message to request a retransmission. In case of group-common NACK-only feedback, the UE devices receiving the same service are assigned via Downlink Control Information (DCI) the same group-common Physical Uplink Control Channel (PUCCH) resource on which the UE devices are to send a signal indicating NACK if the corresponding Physical Downlink Shared Channel (PDSCH) transport block (TB) transmission was not decoded successfully. Only a single NACK bit can be transmitted with this scheme using a single PUCCH resource. When several NACK-only feedback bits are scheduled in the same slot, the UE cannot transmit more than one PUCCH including HARQ feedback in the same slot.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device in a communication network is provided. The terminal device may comprise at least one processor and at least one memory. At least one memory includes computer program code stored thereon. At least one memory and the computer program code may be configured to, with at least one processor, cause the terminal device to perform: receiving, from a network device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device; receiving, from the network device, the multicast transmissions of the one or more services; converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or as an ACK bit when a transmission of the multicast transmissions is successfully received on the at least one HARQ process, the converted HARQ feedback bits comprising more than one bit; multiplexing the converted HARQ feedback bits into a multiplexed HARQ feedback; selecting a physical uplink control channel (PUCCH) resource for transmission of the multiplexed HARQ feedback based at least on the one or more uplink control channel configurations; and transmitting the multiplexed HARQ feedback from the selected PUCCH resource; and transmitting the multiplexed HARQ feedback using the selected PUCCH resource.

In some embodiments, the operation of multiplexing the converted HARQ feedback bits into the multiplexed HARQ feedback comprises: concatenating the converted HARQ feedback bits in an ascending or descending order of PUCCH resource indicators (PRIs) in more than one downlink control information (DCI) to the terminal device from the network device, the more than one DCI schedules PUCCH resources for transmitting HARQ feedback for the multicast transmissions of the one or more services.

In some embodiments, the one or more uplink control channel configurations comprise at least one of the following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between the PUCCH resource for the transmission of the multiplexed HARQ feedback and a size of the multiplexed HARQ feedback.

In some embodiments, the selecting the PUCCH resource comprises: selecting the PUCCH resource from the one or more uplink control channel configurations according to an indicator in a latest DCI that has been decoded by the terminal device.

In some embodiments, at least one memory and the computer program codes are configured to, with at least one processor, cause the terminal device to perform: refraining from including Type 1 codebook in the multiplexed HARQ feedback for the one or more services that the terminal device has not been scheduled to provide HARQ feedback.

In a second aspect, an example embodiment of a network device in a communication network is provided. The network device may comprise at least one processor and at least one memory.

At least one memory includes computer program code stored thereon. At least one memory and the computer program code may be configured to, with at least one processor, cause the network device to perform: transmitting, to a terminal device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device; performing the multicast transmissions of the one or more services to at least the terminal device; and receiving, from the terminal device, multiplexed HARQ feedback from the selected PUCCH resource, wherein the multiplexed HARQ feedback comprises more than one bit indicating that corresponding transmission of the multicast transmission is unsuccessfully received at the terminal device, and the PUCCH resource is determined based at least on the one or more uplink control channel configurations.

In some embodiments, multiplexed HARQ feedback comprises a plurality of HARQ feedback bits concatenated in an ascending or descending order of PUCCH resource indicators (PRIs) in more than one downlink control information (DCI), wherein the more than one DCI schedules PUCCH resources for transmitting the HARQ feedback for the multicast transmissions of the one or more services from the terminal device.

In some embodiments, the one or more uplink control channel configurations comprise at least one of following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between a PUCCH resource for a transmission of the multiplexed HARQ feedback and a size of the multiplexed HARQ feedback.

In some embodiments, the at least one memory and the computer program codes are configured to, with the at least one processor, cause the network device to perform: indicating to the terminal device, a PUCCH resource from the one or more uplink control channel configurations by using an indicator in latest DCI transmitted from the network device to the terminal device.

In a third aspect, an example embodiment of a method implemented at a terminal device in a communication network is provided. The method may comprise receiving, from a network device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device; receiving, from the network device, the multicast transmissions of the one or more services; converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or as an ACK bit when a transmission of the multicast transmissions is successfully received on the at least one HARQ process, the converted HARQ feedback bits comprising more than one bit; multiplexing the converted HARQ feedback bits into a multiplexed HARQ feedback; selecting a physical uplink control channel (PUCCH) resource for transmission of the multiplexed HARQ feedback based at least on the one or more uplink control channel configurations; and transmitting the multiplexed HARQ feedback using the selected PUCCH resource.

In some embodiments, the step of multiplexing the converted HARQ feedback bits into the multiplexed HARQ feedback comprises: concatenating the converted HARQ feedback bits in an ascending or descending order of PUCCH resource indicators (PRIs) in more than one one downlink control information (DCI) to the terminal device from the network device, wherein the more than one DCI schedules PUCCH resources for transmitting the HARQ feedback for the multicast transmissions of the one or more services.

In some embodiments, the one or more uplink control channel configurations comprise at least one of the following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmission of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between the PUCCH resource for the transmission of the multiplexed HARQ feedback and a size of the multiplexed HARQ feedback.

In some embodiments, the selecting the PUCCH resource comprises: selecting the PUCCH resource based at least on the size of the multiplexed HARQ feedback and assistance information.

In some embodiments, at least one memory and the computer program codes are configured to, with at least one processor, cause the terminal device to perform: refraining from including Type 1 codebook in the multiplexed HARQ feedback for the one or more services that the terminal device has not been scheduled to provide HARQ feedback.

In a fourth aspect, an example embodiment of a method implemented at a network device in a communication network is provided. The method may comprise transmitting to a terminal device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device; performing the multicast transmissions of the one or more services to at least the terminal device; and receiving, from the terminal device, multiplexed HARQ feedback from a physical uplink control channel (PUCCH) resource, wherein the multiplexed HARQ feedback comprises more than one bit indicating that corresponding transmission of the multicast transmission is unsuccessfully received at the terminal device on the at least one HARQ process, and the PUCCH resource is determined based at least on the one or more uplink control channel configurations.

In some embodiments, the multiplexed HARQ feedback comprises a plurality of HARQ feedback bits concatenated in an ascending or descending order of uplink control channel resource indicators (PRIs) in more than one downlink control information (DCI), wherein the more than one DCI schedules PUCCH resources for transmitting the HARQ feedback for the transmissions of the one or more services from the terminal device.

In some embodiments, the one or more uplink control channel configurations comprise at least one of following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more service.

In some embodiments, the one or more uplink control channel configurations further comprise assistance information, assistance information comprising a mapping between a PUCCH resource for a transmission of the multiplexed HARQ feedback and a size of the multiplexed HARQ feedback.

In some embodiments, the method further comprises indicating the uplink control channel resource to the terminal device by using a last uplink control channel resource indicator in downlink control information transmitted from the network device to the terminal device.

In a fifth aspect, an example embodiment of an apparatus in a communication network is provided. Apparatus may comprise means for receiving from a network device, one or more uplink control channel configurations for transmitting hybrid automatic repeat request (HARQ) feedback for multicast transmissions of one or more services, wherein the one or more services is configured to transmit at least one HARQ negative acknowledgement (NACK) when at least one transmission of the multicast transmissions on at least one HARQ process between the apparatus and the network device is received unsuccessfully at the terminal device, and to ignore of transmitting at least one HARQ acknowledgement (ACK) when the at least one transmission of the multicast transmissions on the at least one HARQ process is received successfully at the terminal device, means for receiving, from the network device, the multicast transmissions of the one or more services, means for converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or to an ACK bit when a transmission of the multicast transmissions is successfully received on the at least one HARQ process, the converted HARQ feedback bits comprising more than one bit, means for multiplexing the converted HARQ feedback bits into a multiplexed HARQ feedback, means for selecting a physical uplink control channel (PUCCH) resource for transmission of the multiplexed HARQ feedback based at least on the one or more uplink control channel configurations; and transmitting the multiplexed HARQ feedback using the selected PUCCH resource.

In some embodiments, the means for multiplexing the converted HARQ feedback bits into the multiplexed HARQ feedback comprises: means for concatenating the converted HARQ feedback bits in an ascending or descending order of PUCCH resource indicators (PRIs) in more than one downlink control information (DCI) to the terminal device from the network device, the more than one DCI schedules PUCCH resources for transmitting HARQ feedback for the multicast transmissions of the one or more services.

In some embodiments, the one or more uplink control channel configurations comprise at least one of the following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between the PUCCH resource for the transmission of the multiplexed HARQ feedback and a size of the multiplexed HARQ feedback.

In some embodiments, the means for selecting the PUCCH resource comprises: means for selecting the PUCCH resource based at least on the size of the multiplexed HARQ feedback and assistance information.

In some embodiments, apparatus further comprises: means for refraining from including Type 1 codebook in the multiplexed HARQ feedback for the one or more services that the terminal device has not been scheduled to provide HARQ feedback.

In a sixth aspect, an example embodiment of an apparatus in a communication network is provided. Apparatus may comprise means for transmitting, to a terminal device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the apparatus is received unsuccessfully at the terminal device, and to ignore transmitting of at least one HARQ acknowledgement (ACK) when the at least one transmission of the multicast transmissions on the at least one HARQ process is received successfully at the terminal device; means for performing the multicast transmissions of the one or more services to at least the terminal device, and means for receiving, from the terminal device, multiplexed HARQ feedback from a physical uplink control channel (PUCCH) resource, wherein the multiplexed HARQ feedback comprises more than one bit indicating that corresponding transmission of the multicast transmission is unsuccessfully received at the terminal device on the at least one HARQ process, and the PUCCH resource is determined based at least on the one or more uplink control channel configurations.

In some embodiments, the multiplexed HARQ feedback comprises a plurality of HARQ feedback bits concatenated in an ascending or descending order of uplink control channel resource indicators (PRIs) in more than one downlink control information (DCI), wherein the more than one DCI schedules PUCCH resources for transmitting the HARQ feedback for the transmissions of the one or more services from the terminal device.

In some embodiments, the one or more uplink control channel configurations comprise at least one of following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between a PUCCH resource for a transmission of the multiplexed HARQ feedback and a size of the multiplexed HARQ feedback.

In some embodiments, the apparatus further comprises means for indicating the uplink control channel resource to the terminal device by using a last uplink control channel resource indicator in downlink control information transmitted from the network device to the terminal device.

In a seventh aspect, an example embodiment of a computer program is provided. The computer program may comprise instructions stored on a computer readable medium. The instructions may, when executed by at least one processor of a terminal device in a communication network, cause the terminal device to perform: receiving, from a network device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device; receiving, from the network device, the multicast transmissions of the one or more services; converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or as an ACK bit when a transmission of the multicast transmissions is successfully received on the at least one HARQ process, the converted HARQ feedback bits comprising more than one bit; multiplexing the converted HARQ feedback bits into a multiplexed HARQ feedback; selecting a physical uplink control channel (PUCCH) resource for transmission of the multiplexed HARQ feedback based at least on the one or more uplink control channel configurations; and transmitting the multiplexed HARQ feedback using the selected PUCCH resource.

In some embodiments, the multiplexing the converted HARQ feedback bits into the multiplexed HARQ feedback comprises: concatenating the converted HARQ feedback bits in an ascending or descending order of PUCCH resource indicators (PRIs) in more than one downlink control information (DCI) to the terminal device from the network device, the more than one DCI schedules PUCCH resources for transmitting HARQ feedback for the multicast transmissions of the one or more services.

In some embodiments, the one or more uplink control channel configurations comprise at least one of the following: a first uplink control channel configuration indicating one or more first uplink control channel resources, wherein the one or more first uplink control channel resources comprise a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between the PUCCH resource for the transmission of the multiplexed HARQ feedback and a size of the multiplexed HARQ feedback.

In some embodiments, the selecting the PUCCH resource comprises: selecting the PUCCH resource based at least on the size of the multiplexed HARQ feedback and assistance information.

In some embodiments, at least one memory and the computer program codes are configured to, with at least one processor, cause the terminal device to perform: refraining from including Type 1 codebook in the multiplexed HARQ feedback for the one or more services that the terminal device has not been scheduled to provide HARQ feedback.

In an eighth aspect, an example embodiment of a computer program is provided. The computer program may comprise instructions stored on a computer readable medium. The instructions may, when executed by at least one processor of a network device in a communication network, cause the network device to perform: transmitting, to a terminal device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device; performing the multicast transmissions of the one or more services to at least the terminal device; and receiving, from the terminal device, a multiplexed HARQ feedback from a physical uplink control channel (PUCCH) resource, wherein the multiplexed HARQ feedback comprises more than one bit indicating that corresponding transmission of the multicast transmission is unsuccessfully received at the terminal device on the at least one HARQ process, the PUCCH resource is determined based at least on the one or more uplink control channel configurations.

In some embodiments, the multiplexed HARQ feedback comprises a plurality of HARQ feedback bits concatenated in an ascending or descending order of uplink control channel resource indicators (PRIs) in more than one downlink control information (DCI), wherein the more than one DCI schedules PUCCH resources for transmitting the HARQ feedback for the transmissions of the one or more services from the terminal device.

In some embodiments, the one or more uplink control channel configurations comprise at least one of following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In some embodiments, the one or more uplink control channel configurations further comprise assistance information, assistance information comprising a mapping between a PUCCH resource for a transmission of the multiplexed HARQ feedback and a size of the multiplexed HARQ feedback.

In some embodiments, the at least one memory and the computer program codes are configured to, with the at least one processor, cause the network device to perform: indicating the uplink control channel resource to the terminal device by using a last uplink control channel resource indicator in downlink control information transmitted from the network device to the terminal device.

Other features and advantages of the example embodiments of the present disclosure will also be apparent from the following description of specific embodiments when read in conjunction with accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to accompanying drawings.

FIG. 1 is a schematic diagram illustrating a communication system in which example embodiments of the present application can be implemented.

FIG. 2 shows an exemplary sequence diagram for multiplexing NACK-only HARQ feedback according to an embodiment of the present disclosure.

FIG. 3 illustrates an exemplary scenario, where the NACK-only feedback collision occurs and multiplexing would be needed.

FIG. 4 shows the PUCCH resources corresponding to the scheduled resources in FIG. 3 according to an embodiment of the present disclosure.

FIG. 5 shows a flow chart illustrating an example method 500 for the UE device 110 to multiplex NACK-only HARQ feedback according to an example embodiment of the present disclosure.

FIG. 6 shows a block diagram illustrating an example communication network 600 for multiplexing NACK-only HARQ feedback according to an embodiment of the present disclosure.

FIG. 7 shows a flow chart illustrating an example method 700 for multiplexing NACK-only HARQ feedback according to an embodiment of the present disclosure.

FIG. 8 shows a flow chart illustrating an example method 800 for multiplexing NACK-only HARQ feedback according to an embodiment of the present disclosure.

FIG. 9 shows a block diagram illustrating an example apparatus 900 for multiplexing NACK-only HARQ feedback according to an embodiment of the present disclosure.

FIG. 10 shows a block diagram illustrating an example apparatus 1000 for multiplexing NACK-only HARQ feedback according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to accompanying drawings. The following description includes specific details for the purpose of providing a thorough understanding of various concepts. However, it will be apparent to those skilled in art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal, a mobile station, a subscriber station, a portable subscriber station, an access terminal, a computer, a wearable device, an on-vehicle communication device, a machine type communication (MTC) device, an internet of things (IoT) device, an internet of everything (IoE) device, a device-to-device (D2D) communication device, a vehicle to everything (V2X) communication device, a sensor and the like. The term “terminal device” can be used interchangeably with UE, a user terminal, a mobile terminal, a mobile station, or a wireless device.

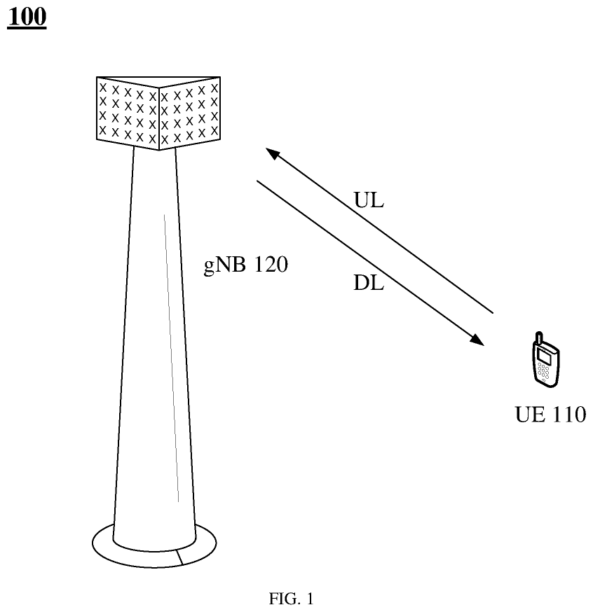

FIG. 1 illustrates a schematic diagram of a communication system 100 in which example embodiments of the present disclosure can be implemented. Referring to FIG. 1, the communication system 100 may include user equipment (UE) device 110 and a base station 120 shown as gNB. The UE device 110 may communicate with the gNB 120 on uplink (UL) and downlink (DL) channels. The UE device 110 and the base station 120 may be a part of a cellular communication network, such as a 5G NR network, in which the UE device 110 may be implemented as an NR-enabled UE device 110, and the base station 120 may be implemented as a next Generation Node-B (gNB). It would be appreciated that the NR network may comprise more than one UE devices 110 and/or more than one gNB 120. The UE device 110 may camp on a cell served by the gNB 120 and wirelessly communicate with the gNB 120 on uplink (UL) and downlink (DL) channels. Although not shown, the gNB 120 may also connect to other base stations via wireless or wired connections. The gNB 120 provides access to the network for the UE device 110.

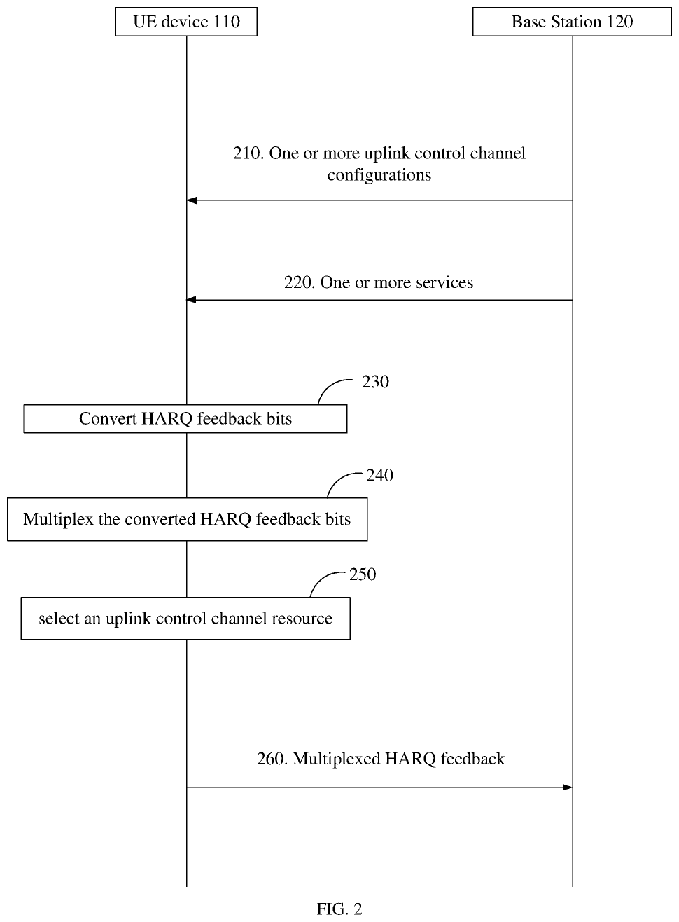

FIG. 2 shows an exemplary sequence diagram for multiplexing NACK-only HARQ feedback according to an embodiment of the present disclosure. Referring to the FIG. 2, the UE device 110 may be a terminal device to transmit NACK-only HARQ feedback on the group-common PUCCH resource or ACK/NACK feedback on orthogonal PUCCH resources. The base station 120 may be a device on network side to perform the HARQ transmission. The UE device 110 is associated with a cell the base station 120 covers.

In an operation 210, the base station 120 may configure the UE device 110 with one or more uplink control channel configurations for transmitting HARQ feedback for multicast transmission of one or more services, wherein the one or more services may be configured to transmit at least one hybrid automatic repeat request (HARQ) negative acknowledgement (NACK) when at least one transmission of the multicast transmissions on at least one HARQ process between the terminal device and the network device is received unsuccessfully at the UE device 110, and the UE device 110 may ignore transmitting at least one HARQ acknowledgement (ACK) when at least one transmission of the multicast transmissions on the at least one HARQ process is received successfully at the UE device 110. That is, the one or more services can be configured to transmit NACK-only HARQ feedback.

In the operation of MBS, when the group-common PDCCH that is scheduling the group-common PDSCH TB reception is received by the UE device 110, the PUCCH resource for the UE device 110 to send its HARQ feedback may be indicated by the DCI in the PDCCH. The timing of the HARQ feedback may be indicated by PDSCH-to-HARQ_feedback_timing_indicator field and the ID of the PUCCH resource to be utilized may be indicated by PUCCH resource indicator field in the DCI. To transmit a HARQ feedback, the UE device 110 may select an appropriate PUCCH-config. The PUCCH-config for the ACK/NACK based multicast can be different than PUCCH-config of unicast. In a case where the ACK/NACK based multicast PUCCH-config is not configured, the UE device 110 may use the unicast PUCCH-config. A separate PUCCH-config for NACK-only based multicast can also be configured.

In one embodiment, the one or more uplink control channel configurations may comprise at least one of following: a first uplink control channel configuration indicating one or more first uplink control channel resources. The one or more first uplink control channel resources comprise PUCCH resources associated with PUCCH configuration for transmission of HARQ NACK feedback on the at least one HARQ process for the multicast transmissions of the one or more services; and a second uplink control channel configuration indicating one or more second uplink control channel resources. The one or more second uplink control channel resources comprise PUCCH resources associated with PUCCH configuration for transmission of HARQ ACK and/or HARQ NACK feedback on the at least one HARQ process for multicast or unicast transmission of the one or more services.

For example, in one embodiment, the UE device 110 can be scheduled to transmit NACK-only HARQ feedback, and a separate PUCCH-config for NACK-only based multicast might be configured. In one case, PUCCH-config for NACK-only feedback can be separate from the PUCCH-config for unicast and ACK/NACK multicast; or, in another case, PUCCH-config for NACK-only feedback might be separate from the PUCCH-config for unicast and same with the ACK/NACK multicast.

In an operation 220, the UE device 110 may receive, from a base station 120, transmissions of one or more services. That is, the UE device 110 may transmit NACK HARQ feedback when at least one of the transmissions is received unsuccessfully at the UE device 110, and, the UE device 110 may ignore transmitting at least one HARQ ACK feedback when at least one of the transmissions are received successfully at the UE device 110. In one embodiment, the one or more services may include group-common NACK-only transmissions. In another embodiment, there may be transmissions for only one service. The one service may have more than one PDSCH transmissions. The more than one PCSCH transmissions may lead to more than one NACK-only bits scheduled in the same uplink slot.

In an operation 230, the UE device 110 may convert HARQ feedback bits of the HARQ feedback for the multicast transmissions of the one or more services by interpreting a HARQ feedback bit of the HARQ feedback as a NACK bit when a transmission of the multicast transmission is unsuccessfully received on the at least one HARQ process or as an ACK bit when a transmission of the multicast transmission is successfully received on the at least one HARQ process, the converted HARQ feedback bits may comprise more than one bit.

In one embodiment, when the UE device 110 is scheduled to perform more than one group-common NACK-only transmission, the converted HARQ feedback bits may comprise more than one bit. Accordingly, the UE device 110 may multiplex the feedback, if the feedback has the same priority based on a DCI priority indicator, when PUCCH resources overlap in time in a slot, because the UE device 110 is not able to transmit more than one PUCCH carrying HARQ feedback in a slot. Meanwhile, if the UE device 110 is scheduled only one NACK-only transmission for this time instance, then the UE device 110 might not need to multiplex the HARQ feedback and can directly transmit the NACK-only HARQ feedback on the group-common PUCCH resource.

In an operation 240, the UE device 110 may multiplex the converted HARQ feedback bits into a multiplexed HARQ feedback. As discussed in operation 230, when the converted HARQ feedback bits may comprise more than one bit, since the UE device 110 is not able to transmit more than one PUCCH carrying HARQ feedback in a slot, the UE device 110 can convert the HARQ feedback bits, which comprise more than one bit, and multiplex the converted HARQ feedback bits into a multiplexed HARQ feedback.

In one embodiment, multiplexing the converted HARQ feedback bits into the multiplexed HARQ feedback may comprise: concatenating the converted HARQ feedback bits in an ascending or descending order of PRIs in more than one DCI to the terminal device from the network device, wherein the more than one DCI schedules PUCCH resources for transmitting HARQ feedback for the multicast transmissions of the one or more services. When several NACK-only feedback bits are scheduled in the same slot, since the UE device 110 cannot transmit more than one PUCCH including HARQ feedback in a slot, the UE device 110 can convert the NACK-only bits to ACK/NACK bits and multiplexes the ACK/NACK bits. Multiplexing can be performed by concatenating the HARQ bits. The concatenation can follow the order of Group Radio Network Temporary Identifier (G-RNTI), if the UE device 110 receives TBs of different MBSs. If the NACK-only HARQ bits in the same slot belong to the same G-RNTI, then the order would follow the order in which corresponding TBs are received bits. Alternatively, the concatenation of the NACK-only HARQ bits can follow the order of PRI fields of the DCI that scheduled PUCCH transmissions. Accordingly, the UE device 110 does not need to group the HARQ bits that belong to the same G-RNTI.

After multiplexing the NACK-only bits which have been converted to ACK/NACK bits, the UE device 110 needs to select the PUCCH resource to transmit the multiplexed HARQ feedback. In an operation 250, the UE device 110 may select an uplink control channel resource for transmission of the multiplexed HARQ feedback based at least on the one or more uplink control channel configurations. The PUCCH resource may be different from a PUCCH resource indicated by a PRI in a latest DCI that has been decoded by the UE device 110 for the multicast transmissions of the one or more services. In some embodiments, in this operation 250, the UE device 110 may determine whether a separate PUCCH-config for NACK-only based multicast is already configured and can select different uplink control channel resources according to the different configurations of the UE device 110 configured by the base station 120 in operation 210.

For example, in one embodiment, if the one or more uplink control channel configurations comprise a first uplink control channel configuration, the UE device 110 can select the first uplink control channel resource from the first uplink control channel configuration for transmission of HARQ NACK feedback for multicast transmission. In this embodiment, the UE device 110 can use the dedicated PUCCH resource indicated in the first uplink control channel configuration for the multiplexed NACK-only feedback for multicast transmission, in a case where the first uplink control channel configuration is configured in operation 210.

In another embodiment, if the one or more uplink control channel configurations do not comprise the first uplink control channel configuration, the selecting an uplink control channel resource may comprise: selecting a second uplink control channel resource from a second uplink control channel configuration. In this embodiment, since no first uplink control channel configuration for transmission of HARQ NACK feedback for multicast transmission is configured in operation 210, the UE device 110 can use the dedicated PUCCH resource associated with PUCCH configuration for transmission of HARQ ACK and/or HARQ NACK feedback for multicast or unicast transmission.

In one embodiment, the one or more uplink control channel configurations further comprise assistance information, and the assistance information may comprise a mapping between the PUCCH resource for the transmission of the multiplexed HARQ feedback and a size of the multiplexed HARQ feedback. According to one embodiment, the selecting the PUCCH resource may comprise: selecting the PUCCH resource based at least on the size of the multiplexed HARQ feedback and the assistance information. The group-common NACK-only resource that is pointed by the last DCI cannot be used by the UE device 110 to transmit multiplexed feedback, as this transmission would collide with other UE devices' NACK-only transmissions in the group-common PUCCH resource. In the present embodiment, the UE device 110 can be configured with a PUCCH resource in the NACK-only PUCCH-config. The resource may be selected by the UE device 110 when NACK-only bits are converted to ACK/NACK bits and multiplexed. Since there are currently up to 16 HARQ processes, there can be up to 16 bits of NACK-only to be converted to ACK/NACK bits in a slot. Thus, the specific PUCCH resource for multiplexed HARQ feedback can be configured based on the number of ACK/NACK bits of the multiplexed HARQ feedback. In this way, the NACK-only PUCCH-config would include PUCCH format 0 and 1 resources to transmit NACK-only feedback, as well as one or several PUCCH resources of format 2, 3 and/or 4 to transmit a multiplexed version of the NACK-only bits. In some embodiments, several PUCCH resources can be configured, and the UE can select one of the configured PUCCH resources based on the size of the multiplexed HARQ feedback.

In another embodiment, the uplink control channel resource is selected according to an indicator in a latest DCI that has been decoded by the UE device 110. Although, as discussed above, the group-common NACK-only resource that is pointed by the latest DCI cannot be used by the UE to transmit multiplexed feedback, the latest PRI in the DCI can be used to select the PUCCH resource for the multiplexed feedback among a set of new PUCCH resources. For example, the set of new PUCCH resources may comprise one or more first uplink control channel resources. For that purpose, mod (PRI, set-size) can be used to remap the PRI to the configured number of PUCCH resources.

In an operation 250, the UE device 110 may transmit the multiplexed HARQ feedback using the selected PUCCH resource.

In one embodiment, the UE device 110 may refrain from including Type 1 codebook in the multiplexed HARQ feedback for the one or more services that the terminal device has not been scheduled to provide HARQ feedback. In another solution, in a case where the UE device 110 is configured with Type-1 codebook for unicast or multicast ACK/NACK, the UE might send HARQ bits even if there were no TBs scheduled/received. According to the present embodiment, if the UE utilizes the specific PUCCH resource in the NACK-only PUCCH-config to provide multiplexed NACK-only feedback, then the UE does not need to produce Type-1 codebook for unicast or multicast ACK/NACK, unless there are corresponding transmissions for the unicast or multicast ACK/NACK. This would save significant amount of PUCCH overhead.

According to the present disclosure, the base station 120's decoding process of PUCCH resources can become more efficient. The base station 120 would only need to decode the group-common PUCCH for the services, whose UE devices are not interested in any other services that have PUCCH resources scheduled in that time instance.

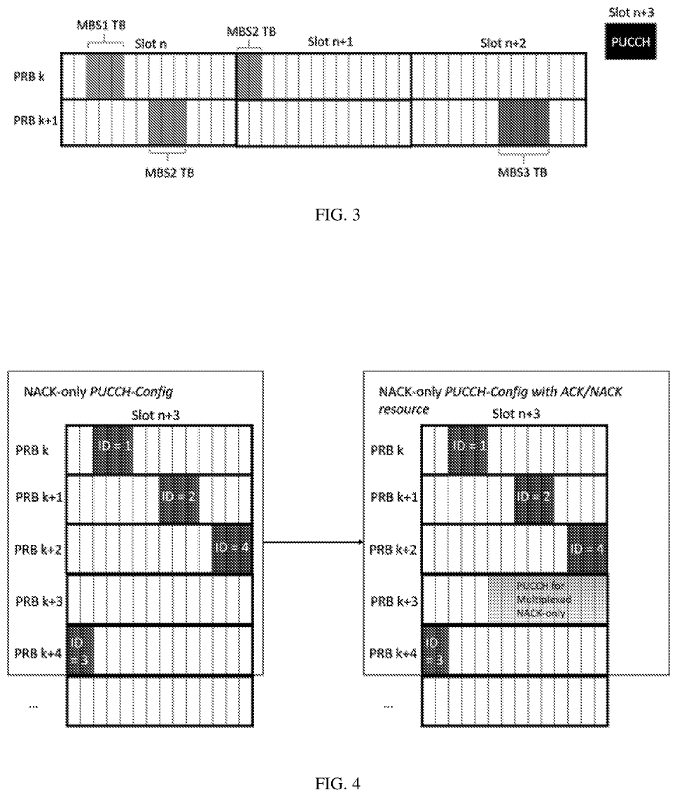

For example, FIG. 3 illustrates an exemplary scenario, where the NACK-only feedback collision occurs and multiplexing would be needed. The UE device 110 is interested in three different MBSs, whose PDCCH and PDSCH are scrambled by different G-RNTIs labeled as MBS1, MBS2 and MBS3, and several TBs are received, accordingly. If the NACK-only feedback scheme is used for HARQ for all those services, and if the corresponding HARQ feedback transmissions are scheduled for slot n+3, then the UE device 110 may multiplex the feedback and transmit in a proper PUCCH resource, since more than one NACK-only HARQ feedback bits are scheduled to be transmitted in the same slot. FIG. 4 shows the PUCCH resources corresponding to the scheduled resources in FIG. 3 according to an embodiment of the present disclosure.

Assume that the PUCCH resources in FIG. 4 correspond to the scheduled resources in FIG. 3 at slot n+3. Also, assume that there are some UE devices in the system that are only interested in MBS service 1, and other UE devices are interested in all services 1, 2 and 3. Then, the base station needs to decode the corresponding NACK-only group-common PUCCH resource only for service 1, and to decode the PUCCH resources that are configured for the multiplexed feedback for the others. For example, the PUCCH resources configured for the multiplexed feedback may comprise one or more first uplink control channel resources. In addition, by not transmitting other Type-1 ACK/NACK codebooks, significant amount of PUCCH bits would be saved.

In some other embodiments, the UE device 110 may convert the NACK-only feedback scheduled for a time slot to ACK/NACK feedback and multiplex, only when more than 1 NACK is to be sent by the UE device 110. If all the corresponding TBs were decoded successfully, then the UE device 110 may not send a feedback indicating all ACKs in the newly configured PUCCH resource. For example, the newly configured PUCCH resources configured for the multiplexed feedback may comprise one or more first uplink control channel resources. In some other embodiments, all-ACK feedback may indeed be sent, as the base station 120 expects-based on its scheduling decisions-ACK/NACK feedback transmission from the UE device 110 on this PUCCH resource. This may avoid the usual ACK-DTX confusion problem of NACK-only feedback in this situation. If only one of the corresponding TBs was decoded unsuccessfully, the UE device 110 can utilize the corresponding NACK-only resource, but not produce any ACK feedback for the other TBs. For example, if the UE device 110 was scheduled to provide NACK-only feedback in a slot for 3 different TBs, and only one of them could not be successfully decoded, the UE device 110 may only send one NACK feedback in the group-common PUCCH resource, and not utilize the newly configured PUCCH resource for the multiplexed NACK-only feedback.

For this embodiment, the base station 120 might need to do more decoding attempts. However, PUCCH overhead in uplink would be reduced and UE device 110 may save power if all the TBs are received correctly by not transmitting any feedback.

In some other embodiments, the newly configured PUCCH resource or set of PUCCH resources for transmitting the multiplexed NACK-only feedback can be configured within multicast ACK/NACK PUCCH-config or unicast PUCCH-config. This configuration can include PUCCH resource ID(s). The UE device 110 would then utilize the corresponding PUCCH resource when transmitting multiplexed NACK-only feedback. Again, the UE device 110 may not produce other Type-1 HARQ codebooks when utilizing the specific PUCCH resource. This embodiment may be used if there is no distinct NACK-only PUCCH-config, or when it is configured to be the same with ACK/NACK multicast PUCCH-config.

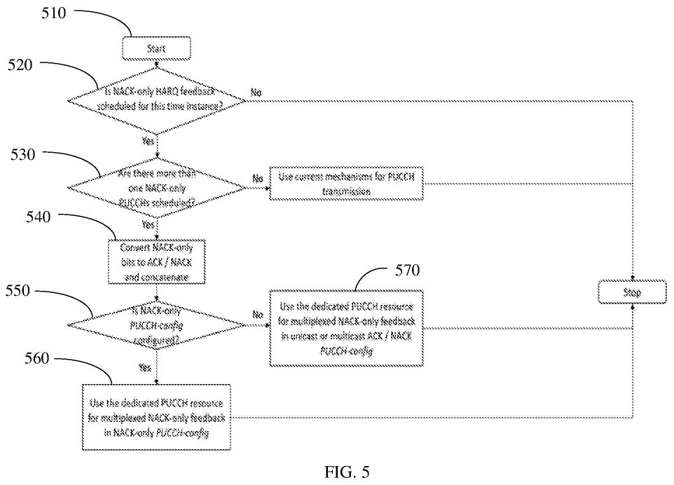

FIG. 5 shows a flow chart illustrating an example method 500 for the UE device 110 to multiplex NACK-only HARQ feedback according to an example embodiment of the present disclosure.

At start 510, the UE device 110 might be configured for transmitting HARQ feedback for multicast transmission of one or more services. To transmit a HARQ feedback, the UE device 110 may be configured with an appropriate PUCCH-config. The PUCCH-config for ACK/NACK based multicast can be different than that of unicast. In case ACK/NACK based multicast PUCCH-config is not configured, the UE device 110 may use the unicast PUCCH-config. A separate PUCCH-config for NACK-only based multicast can also be configured.

At step 520, the UE device 110 may determine if NACK-only HARQ feedback is scheduled for the time instance. If no NACK-only HARQ feedback is scheduled for the time instance, then stop.

If NACK-only HARQ feedback is scheduled for the time instance, then at step 530, the UE device 110 may determine if there are more than one NACK-only feedback scheduled. If only one NACK-only PUCCH is scheduled, then the UE device 110 can use the current mechanism for transmitting the NACK-only feedback on PUCCH.

If there are more than one NACK-only feedback scheduled for the time instance, then at step 540, the UE device 110 may convert NACK-only bits to ACK/NACK and multiplex the converted ACK/NACK bits by concatenating the converted ACK/NACK bits.

Then at step 550, the UE device 110 may determine whether the NACK-only PUCCH-config is configured for the multiplexed feedback at step 510

If the NACK-only PUCCH-config is configured for the multiplexed feedback, then at step 560, the UE device 110 may use the dedicated PUCCH resource for multiplexed NACK-only feedback in NACK-only PUCCH-config.

On the other hand, if the NACK-only PUCCH-config is not configured for the multiplexed feedback, then at step 570, the UE device 110 may use the dedicated PUCCH resource for multiplexed NACK-only feedback in unicast or multicast ACK/NACK PUCCH-cogfig.

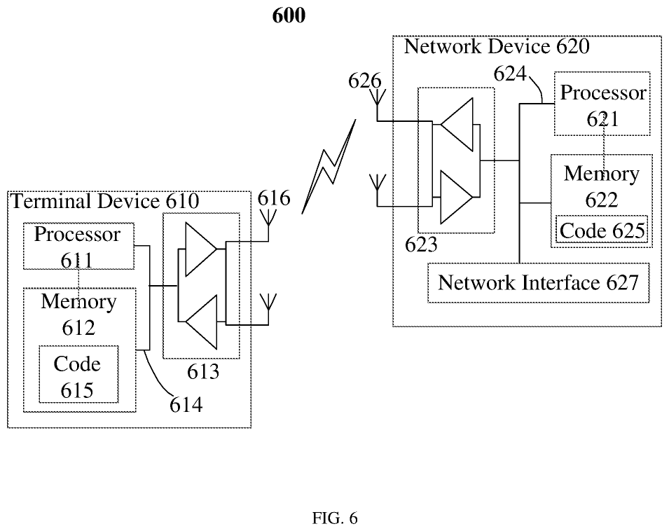

FIG. 6 is a block diagram illustrating a communication network 600 in which example embodiments of the present disclosure can be implemented. The communication network 600 may be a part of a larger communication network or system. As shown in FIG. 6, the communication network 600 may include a terminal device 610 which may be implemented as the UE device 110 discussed above, and a network device 620 which may be implemented as the base station (gNB) 120 discussed above.

Referring to FIG. 6, the terminal device 610 may comprise one or more processors 611, one or more memories 612 and one or more transceivers 613 interconnected through one or more buses 614. The one or more buses 614 may be address, data, or control buses, and may include any interconnection mechanism such as series of lines on a motherboard or integrated circuit, copper cables, optical fibers, or other electrical/optical communication equipment, and the like. Each of the one or more transceivers 613 may comprise a receiver and a transmitter, which are connected to a plurality of antennas 616. The plurality of antennas 616 may form an antenna array to perform beamforming communication with the network device 620. The one or more memories 612 may include computer program code 615. The one or more memories 612 and the computer program code 615 may be configured to, when executed by the one or more processors 611, cause the terminal device 610 to perform operations and procedures relating to the UE device 110 as described above.

The network device 620 may be implemented as a single network node, or disaggregated/distributed over two or more network nodes, such as a central unit (CU), a distributed unit (DU), a remote radio head-end (RRH), using different functional-split architectures and different interfaces. The network device 620 may comprise one or more processors 621, one or more memories 622, one or more transceivers 623 and one or more network interfaces 627 interconnected through one or more buses 624. The one or more buses 624 may be address, data, or control buses, and may include any interconnection mechanism such as a series of lines on a motherboard or integrated circuit, copper cables, optical fibers, or other electrical/optical communication equipment, and the like. Each of the one or more transceivers 623 may comprise a receiver and a transmitter, which are connected to a plurality of antennas 626. The network device 620 may operate as a base station for the terminal device 610 and wirelessly communicate with the terminal device 610 through the plurality of antennas 626. The plurality of antennas 626 may form an antenna array to perform beamforming communication with the terminal device 610. The one or more network interfaces 627 may provide wired or wireless communication links through which the network device 620 may communicate with other network devices, entities or functions. The one or more memories 622 may include computer program code 625. The one or more memories 622 and the computer program code 625 may be configured to, when executed by the one or more processors 621, cause the network device 620 to perform operations and procedures relating to the base station (gNB) 120 as described above.

The one or more processors 611, 621 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 611, 621 may be configured to control other elements of the UE/network device and operate in cooperation with them to implement the procedures discussed above.

The one or more memories 612, 622 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 612, 622 may include but not limited to an electric, a magnetic, an optical, an electromagnetic, an infrared, or a semiconductor system, apparatus, or device or any combination of above.

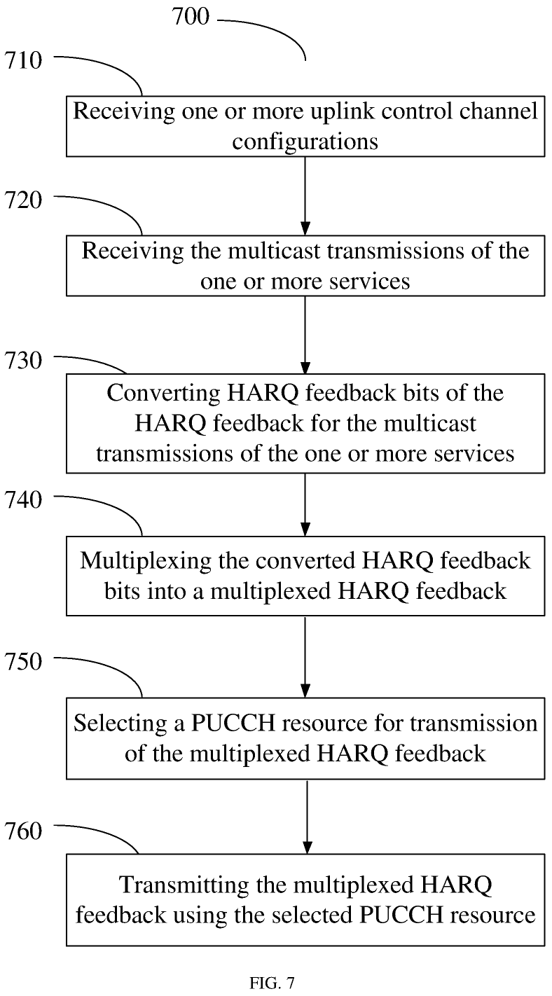

FIG. 7 shows a flow chart illustrating an example method 700 for multiplexing NACK-only HARQ feedback according to an embodiment of the present disclosure. The example method 700 may be performed for example at a terminal device such as the UE device 110.

Referring to the FIG. 7, the example method 700 may include a step 710 of receiving, from a network device, one or more uplink control channel configurations for transmitting hybrid automatic repeat request (HARQ) feedback for multicast transmissions of one or more services, wherein the one or more services is configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device, a step 720 of receiving, from the network device, the multicast transmissions of the one or more services, a step 730 of converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or as an ACK bit when a transmission of the multicast transmissions is successfully received on the at least one HARQ process, the converted HARQ feedback bits comprising more than one bit, a step 740 of multiplexing the converted HARQ feedback bits into a multiplexed HARQ feedback, a step 750 of selecting a physical uplink control channel (PUCCH) resource for transmission of the multiplexed HARQ feedback based at least on the one or more uplink control channel configurations; and transmitting the multiplexed HARQ feedback from the selected PUCCH resource, and a step 760 of transmitting the multiplexed HARQ feedback using the selected PUCCH resource.

Details of the step 710 have been described in above descriptions with respect to at least the operation 210, and repetitive descriptions thereof are omitted here.

Details of the step 720 have been described in above descriptions with respect to at least the operation 220, and repetitive descriptions thereof are omitted here.

Details of the step 730 have been described in above descriptions with respect to at least the operation 230, and repetitive descriptions thereof are omitted here.

Details of the step 740 have been described in above descriptions with respect to at least the operation 240, and repetitive descriptions thereof are omitted here.

Details of the step 750 have been described in above descriptions with respect to at least the operation 250, and repetitive descriptions thereof are omitted here.

Details of the step 760 have been described in above descriptions with respect to at least the operation 260, and repetitive descriptions thereof are omitted here.

In an embodiment, the step 740 of multiplexing the converted HARQ feedback bits into the multiplexed HARQ feedback comprises: concatenating the converted HARQ feedback bits in an ascending or descending order of PUCCH resource indicators (PRIs) in more than one downlink control information (DCI) to the terminal device from the network device, the more than one DCI scheduling PUCCH resources for transmitting HARQ feedback for the multicast transmissions of the one or more services.

In an embodiment, the one or more uplink control channel configurations comprise at least one of the following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In an embodiment, the one or more uplink control channel configurations further comprise assistance information, assistance information comprising a mapping between the PUCCH resource for the transmission of the multiplexed HARQ feedback and a size of the multiplexed HARQ feedback.

In an embodiment, the step 750 of selecting the PUCCH resource comprises: selecting the PUCCH resource based at least on the size of the multiplexed HARQ feedback and assistance information.

In an embodiment, the step 750 of selecting the PUCCH resource comprises: selecting the PUCCH resource according to a latest PRI in downlink control information that has been decoded by the terminal device.

In an embodiment, at least one memory and the computer program codes are configured to, with at least one processor, cause the terminal device to perform: refraining from including Type 1 codebook in the multiplexed HARQ feedback for the one or more services that the terminal device has not been scheduled to provide HARQ feedback.

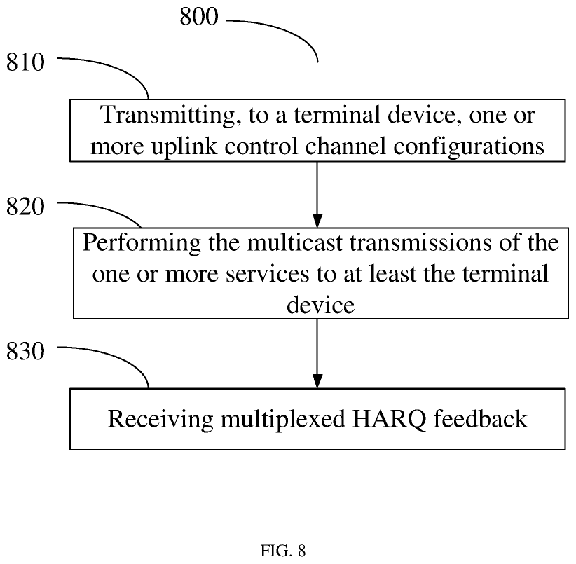

FIG. 8 shows a flow chart illustrating an example method 800 for multiplexing NACK-only HARQ feedback according to an embodiment of the present disclosure. The example method 800 may be performed for example at a network device such as the base station 120.

Referring to the FIG. 8, the example method 800 may include a step 810 of transmitting to a terminal device, one or more uplink control channel configurations for transmitting hybrid automatic repeat request (HARQ) feedback for multicast transmissions of one or more services, wherein the one or more services is configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device, a step 820 of performing the multicast transmissions of the one or more services to at least the terminal device, and a step 830 of receiving, from the terminal device, multiplexed HARQ feedback from a PUCCH resource, wherein the multiplexed HARQ feedback comprises more than one bit indicating that corresponding transmission of the multicast transmission is unsuccessfully received at the terminal device on the at least one HARQ process, the PUCCH resource may be determined based at least on the one or more uplink control channel configurations.

Details of the step 810 have been described in above descriptions with respect to at least the operation 210, and descriptions thereof are omitted here.

Details of the step 820 have been described in above descriptions with respect to at least the operation 220, and repetitive descriptions thereof are omitted here.

Details of the step 830 have been described in above descriptions with respect to at least the operation 260, and repetitive descriptions thereof are omitted here.

In an embodiment, the multiplexed HARQ feedback comprises a plurality of HARQ feedback bits concatenated in an ascending or descending order of uplink control channel resource indicators (PRIs) in more than one downlink control information (DCI), wherein the more than one DCI schedules uplink control channel resources for transmitting HARQ feedback for the transmissions of the one or more services from the terminal device.

In an embodiment, the one or more uplink control channel configurations comprise at least one of following: a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

In an embodiment, the one or more uplink control channel configurations further comprise assistance information, assistance information comprising a mapping between a PUCCH resource for a transmission of the multiplexed HARQ feedback and a size of the multiplexed HARQ feedback.

In an embodiment, the method further comprises indicating the uplink control channel resource to the terminal device by using a last uplink control channel resource indicator in downlink control information transmitted from the network device to the terminal device.

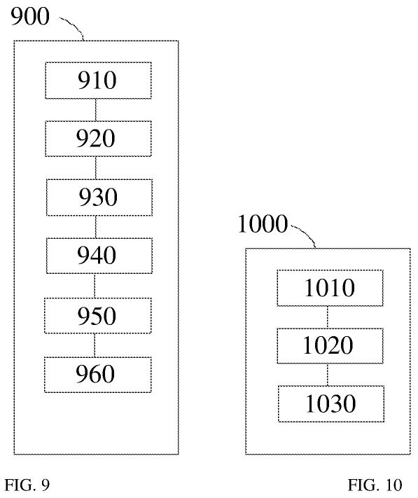

FIG. 9 shows a block diagram illustrating an example apparatus 900 for multiplexing NACK-only HARQ feedback according to an embodiment of the present disclosure. Apparatus, for example, may be at least part of the UE device 110 in above examples.

As shown in FIG. 9, the example apparatus 900 may include means 910 for performing the step 710 of the example method 700, means 920 for performing the step 720 of the example method 700, means 930 for performing the step 730 of the example method 700, means 940 for performing the step 740 of the example method 700, means 950 for performing the step 750 of the example method 700, and means 960 for performing the step 760 of the example method 700. In one or more another example embodiment, at least one I/O interface, at least one antenna element, and the like may also be included in the example apparatus 900.

In some example embodiments, examples of means in the example apparatus 900 may include circuitries. For example, an example of means 910 may include a circuitry configured to perform the step 710 of the example method 700, an example of means 920 may include a circuitry configured to perform the step 720 of the example method 700, an example of means 930 may include a circuitry configured to perform the step 730 of the example method 700, and an example of means 940 may include a circuitry configured to perform the step 740 of the example method 700, an example of means 950 may include a circuitry configured to perform the step 750 of the example method 700, and an example of means 960 may include a circuitry configured to perform the step 760 of the example method 700. In some example embodiments, examples of means may also include software modules and any other suitable function entities.

FIG. 10 shows a block diagram illustrating an example apparatus 1000 for multiplexing NACK-only HARQ feedback according to an embodiment of the present disclosure. Apparatus, for example, may be at least part of the base station 120 in above examples.

As shown in the FIG. 10, the example apparatus 1000 may include means 1010 for performing the step 510 of the example method 500, means 1020 for performing the step 520 of the example method 500, and means 1030 for performing the step 530 of the example method 500. In one or more other example embodiments, at least one I/O interface, at least one antenna element, and the like may also be included in the example apparatus 1000.

In some example embodiments, examples of means in the example apparatus 1000 may include circuitries. For example, an example of means 1010 may include a circuitry configured to perform the step 510 of the example method 500, an example of means 1020 may include a circuitry configured to perform the step 520 of the example method 500, and an example of means 1030 may include a circuitry configured to perform the step 530 of the example method 500. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of above.

Unless the context clearly requires otherwise, throughout the description and the claims, the words “comprise.” “comprising.” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below.” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may.” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of some embodiments described above can be combined to provide further embodiments. Accompanying claims and their equivalents are intended to cover such forms or modifications as would fall within the scope and spirit of the disclosure.

Abbreviations used in the description and/or in the figures are defined as follows:
5G fifth generation
ACK acknowledgement
BS base station
DCI downlink control information
HARQ hybrid automatic repeat request
gNB next generation NodeB/5G base station
G-RNTI Group-RNTI
MBS multicast broadcast service
NACK negative acknowledgement
PDSCH physical downlink shared channel
PRI PUCCH resource indicators
PTM point to multipoint
PUCCH physical uplink control channel
PUSCH physical uplink shared channel
RRC radio resource control
TB transport block
UE user equipment

1. A terminal device comprising:
at least one processor; and
at least one memory comprising computer program code, the at least one memory and the computer program code being configured to, with the at least one processor, cause the terminal device to perform;
receiving, from a network device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device;
receiving, from the network device, the multicast transmissions of the one or more services;
converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or as an ACK bit when a transmission of the multicast transmissions is successfully received on the at least one HARQ process, the converted HARQ feedback bits comprising more than one bit;
multiplexing the converted HARQ feedback bits into a multiplexed HARQ feedback;
selecting a physical uplink control channel (PUCCH) resource for transmission of the multiplexed HARQ feedback based at least on the one or more uplink control channel configurations; and
transmitting the multiplexed HARQ feedback using the selected PUCCH resource.

2. The terminal device of claim 1, wherein the multiplexing the converted HARQ feedback bits into the multiplexed HARQ feedback comprises:
concatenating the converted HARQ feedback bits in an ascending or descending order of PUCCH resource indicators (PRIs) in more than one downlink control information (DCI) to the terminal device from the network device, the more than one DCI scheduling PUCCH resources for transmitting HARQ feedback for the multicast transmissions of the one or more services.

3. The terminal device of claim 1, wherein the one or more uplink control channel configurations comprise at least one of the following:
a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and
a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

4. The terminal device of claim 3, wherein the one or more uplink control channel configurations further comprise assistance information, the assistance information comprising a mapping between the PUCCH resource for the transmission of the multiplexed HARQ feedback and a size of the multiplexed HARQ feedback.

5. The terminal device of claim 4, wherein the selecting the PUCCH resource comprises:
selecting the PUCCH resource based at least on the size of the multiplexed HARQ feedback and the assistance information.

6. The terminal device of claim 1, wherein the selecting the PUCCH resource comprises:
selecting the PUCCH resource from the one or more uplink control channel configurations according to an indicator in a latest DCI that has been decoded by the terminal device.

7. The terminal device of claim 1, wherein the at least one memory and the computer program codes are configured to, with the at least one processor, cause the terminal device to perform:
refraining from including Type 1 codebook in the multiplexed HARQ feedback for the one or more services that the terminal device has not been scheduled to provide HARQ feedback.

8. A network device comprising:
at least one processor; and
at least one memory comprising computer program code, the at least one memory and the computer program code being configured to, with the at least one processor, cause the network device to perform;
transmitting, to a terminal device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device;
performing the multicast transmissions of the one or more services to at least the terminal device; and
receiving, from the terminal device, a multiplexed HARQ feedback from a physical uplink control channel (PUCCH) resource, wherein
the multiplexed HARQ feedback comprises more than one bit indicating that corresponding transmission of the multicast transmission is unsuccessfully received at the terminal device on the at least one HARQ process, the PUCCH resource being determined based at least on the one or more uplink control channel configurations.

9. The network device of claim 8, wherein the multiplexed HARQ feedback comprises a plurality of HARQ feedback bits concatenated in an ascending or descending order of PUCCH resource indicators (PRIs) in more than one downlink control information (DCI), the more than one DCI scheduling PUCCH resources for transmitting the HARQ feedback for the multicast transmissions of the one or more services from the terminal device.

10. The network device of claim 8, wherein the one or more uplink control channel configurations comprise at least one of following:
a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and
a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

11. The network device of claim 10, wherein the one or more uplink control channel configurations further comprise assistance information, the assistance information comprising a mapping between a PUCCH resource for a transmission of the multiplexed HARQ feedback and a size of the multiplexed HARQ feedback.

12. The network device of claim 8, wherein the at least one memory and the computer program codes are configured to, with the at least one processor, cause the network device to perform:
indicating to the terminal device, a PUCCH resource from the one or more uplink control channel configurations by using an indicator in latest DCI transmitted from the network device to the terminal device.

13. A method implemented at a terminal device in a communication network, comprising:
receiving, from a network device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device;
receiving, from the network device, the multicast transmissions of the one or more services;
converting HARQ feedback bits of the HARQ feedback for the multicast transmissions of the one or more services by interpreting a HARQ feedback bit of the HARQ feedback bits as a NACK bit when a transmission of the multicast transmission is unsuccessfully received on the at least one HARQ process or as an ACK bit when a transmission of the multicast transmissions is successfully received on the at least one HARQ process, the converted HARQ feedback bits comprising more than one bit;
multiplexing the converted HARQ feedback bits into a multiplexed HARQ feedback;
selecting a physical uplink control channel (PUCCH) resource for transmission of the multiplexed HARQ feedback based at least on the one or more uplink control channel configurations; and
transmitting the multiplexed HARQ feedback using the selected PUCCH resource.

14. The method of claim 13, wherein the multiplexing the converted HARQ feedback bits into the multiplexed HARQ feedback comprises:
concatenating the converted HARQ feedback bits in an ascending or descending order of PUCCH resource indicators (PRIs) in more than one DCI to the terminal device from the network device, wherein the more than one downlink control information (DCI) schedules PUCCH resources for transmitting the HARQ feedback for the multicast transmissions of the one or more services.

15. The method of claim 13, wherein the one or more uplink control channel configurations comprise at least one of the following:
a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmission of the one or more services; and
a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

16. The method of claim 15, wherein the one or more uplink control channel configurations further comprise assistance information, the assistance information comprising a mapping between the PUCCH resource for the transmission of the multiplexed HARQ feedback and a size of the multiplexed HARQ feedback.

17. The method of claim 16, wherein the selecting the PUCCH resource comprises:
selecting the PUCCH resource based at least on the size of the multiplexed HARQ feedback and the assistance information.

18.-19. (canceled)

20. A method implemented at a network device in a communication network, comprising:
transmitting to a terminal device, one or more uplink control channel configurations for transmitting hybrid automatic repeat request (HARQ) feedback for multicast transmissions of one or more services, the one or more services being configured to transmit at least one HARQ negative acknowledgement (NACK) when at least one transmission of the multicast transmissions on at least one HARQ process between the terminal device and the network device is received unsuccessfully at the terminal device, and to ignore transmitting of at least one HARQ acknowledgement (ACK) when the at least one transmission of the multicast transmissions on the at least one HARQ process is received successfully at the terminal device;
performing the multicast transmissions of the one or more services to at least the terminal device; and
receiving, from the terminal device, a multiplexed HARQ feedback from a physical uplink control channel (PUCCH) resource, wherein
the multiplexed HARQ feedback comprises more than one bit indicating that corresponding transmission of the multicast transmission is unsuccessfully received at the terminal device on the at least one HARQ process, the PUCCH resource being determined based at least on the one or more uplink control channel configurations.

21. The method of claim 20, wherein the multiplexed HARQ feedback comprises a plurality of HARQ feedback bits concatenated in an ascending or descending order of PUCCH resource indicators (PRIs) in more than one downlink control information (DCI), wherein the more than one DCI schedules PUCCH resources for transmitting the HARQ feedback for the multicast transmissions of the one or more services from the terminal device.

22. The method of claim 20, wherein the one or more uplink control channel configurations comprise at least one of following:
a first uplink control channel configuration indicating one or more first uplink control channel resources, wherein the one or more first uplink control channel resources comprise PUCCH resources being associated with PUCCH configuration for transmission of HARQ NACK feedback on the at least one HARQ process for the multicast transmissions of the one or more services; and
a second uplink control channel configuration indicating one or more second uplink control channel resources, wherein the one or more second uplink control channel resources comprise PUCCH resources being associated with PUCCH configuration for transmission of HARQ ACK and/or HARQ NACK feedback on the at least one HARQ process for multicast or unicast transmission of the one or more services.

23.-28. (canceled)
